(19) United States
(12) Patent Application Publication
(10) Pub. No.: US 2012/0047581 A1
(43) Pub. Date: Feb. 23, 2012

(54) EVENT-DRIVEN AUTO-RESTORATION OF WEBSITES

(76) Inventors: Anirban Banerjee, Pasadena, CA (US); Michalis Faloutsos, Riverside, CA (US)

(21) Appl. No.: 13/208,971

(22) Filed: Aug. 12, 2011

Related U.S. Application Data
(60) Provisional application No. 61/372,863, filed on Aug. 12, 2010.

(51) Int. Cl. G06F 21/00

(52) U.S. Cl. 726/24; 726/23

(57) ABSTRACT

An event-driven auto-restoration system for websites comprises a processing system. The processing system is configured to detect an event associated with a website indicative of a change in the website to an undesired state. The processing system is further configured to dynamically generate a restoration process and employ the restoration process to restore the website to a desired state. The processing system is further configured to employ a verification process to verify that the website has been restored to the desired state.

### RELATED APPLICATIONS

This application is related to and claims priority to U.S. Provisional Patent Application No. 61/372,863, entitled “EDWAR: Event-Driven Website Auto-Restoration” filed on Aug. 12, 2010, and which is hereby incorporated by reference in its entirety.

### TECHNICAL BACKGROUND

The use of communication networks to send and receive information has become increasingly prominent. For example, individuals and businesses frequently access websites to conduct business transactions, transfer information, share ideas, experience entertainment media, and utilize other services. However, as a result of the increased use of communication networks, websites have also become increasingly vulnerable to attacks by malicious individuals and/or software applications.

The security of a website is of great importance to those who operate, host, insure, or are otherwise involved in the provision of a website. In addition, users who access the website often demand assurance that the website is safe, secure, and will not harm the user's computer system. Unfortunately, despite security precautions, a website could still be subject to intrusions by computer hackers, malware, viruses, and other malicious attacks. Such attacks can harm the reputation of the website, which can result in decreased traffic to the site and negatively impact the goals of the website operator.

### OVERVIEW

A method of operating an event-driven auto-restoration system for websites is disclosed. The method comprises detecting an event associated with a website indicative of a change in the website to an undesired state. The method further comprises dynamically generating a restoration process, and employing the restoration process to restore the website to a desired state. The method further comprises employing a verification process to verify that the website has been restored to the desired state.

An event-driven auto-restoration system for websites comprises a processing system. The processing system is configured to detect an event associated with a website indicative of a change in the website to an undesired state. The processing system is further configured to dynamically generate a restoration process and employ the restoration process to restore the website to a desired state. The processing system is further configured to employ a verification process to verify that the website has been restored to the desired state.

A computer-readable medium having program instructions stored thereon for operating an event-driven auto-restoration system for websites is disclosed. The computer-readable medium comprises a monitoring software module configured to direct the event-driven auto-restoration system to detect an event associated with a website indicative of a change in the website to an undesired state. The computer-readable medium further comprises a restoration software module configured to direct the event-driven auto-restoration system to dynamically generate a restoration process and employ the restoration process to restore the website to a desired state. The computer-readable medium further comprises a verification software module configured to direct the event-driven auto-restoration system to employ a verification process to verify that the website has been restored to the desired state.

### BRIEF DESCRIPTION OF THE DRAWINGS

FIG. 1 is a block diagram that illustrates a communication system.

FIG. 2 is a flow diagram that illustrates an operation of the communication system.

FIG. 3 is a block diagram that illustrates a communication system in an exemplary embodiment.

FIG. 4 is a block diagram that illustrates a graphical user interface in an exemplary embodiment.

FIG. 5 is a block diagram that illustrates an operation of a communication system in an exemplary embodiment.

FIG. 6 is a block diagram that illustrates an event-driven auto-restoration system.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Conventions:
a) The article ‘a’ is not meant to limit the present system to the example given but rather allows a plurality of alternatives.
b) The term “including” introduces one or more examples of its antecedent, and such examples are not exclusive or preclusive of additional examples; i.e., the term “including” as used herein is understood as meaning “including without limitation.”

The present disclosure proposes systems and methods that may be utilized to detect events associated with a website that are indicative of a change in the website to an undesired state, and to react to such detected events in order to protect the reputation of the website. The system thus facilitates the automated restoration and verification of a website to a desired level of operation and functionality in order to maintain the reputation of the website in good standing among measurement and classification studies and tools such as search engine crawlers. The assessment of the website for event detection and/or verification could include analyzing a plurality of factors associated with the operation of the website. These factors may include the current state, safety level, and functionality of the website, including the actual content of the website, and may further include external information and historical events associated with the website, along with other considerations.

While not required, in some examples the system could include but is not limited to the following properties and functions:
(a) The system employs a verification process after employing a restoration process to ensure that subsequent crawls by search engines, security and measurement entities, and other systems will reinstate the reputation of the website if the reputation was tarnished.
(b) The system may employ an automated and iterative process to restore a website and verify that the website is properly restored with robust operation and in good standing. If the verification process fails to verify that the website has been restored to a desired state, a new restoration process is invoked, and the steps repeat.
(c) The restoration process considers the reputation of the IP address that hosts the website, and takes restorative action if the reputation of the IP address is unacceptable as specified by the system operator and/or the website owner.

The system can employ a tunable rule-based operation to restore a website according to best practices and/or user preferences, while taking into account the specific events detected that prompted the restoration. In some examples, the system could employ multiple techniques of restoration, including but not limited to:
(a) replacing the offending pages;
(b) restoring the website from a previously backed up version of the site;
(c) removing the offending code and related web objects; and
(d) redirecting visitors or search engine crawlers to a temporary backup copy of the website (which is deemed free of malware) to prevent any unwanted spread of malware infections until the website is cleaned.

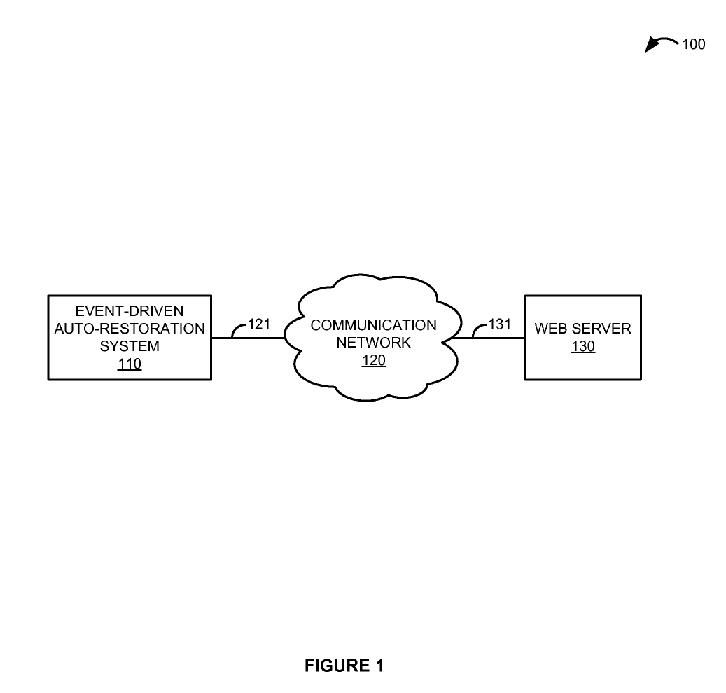

Referring now to FIG. 1, an exemplary system architecture is shown in communication system 100. Communication system 100 includes event-driven auto-restoration system 110, communication network 120, and web server 130. Event-driven auto-restoration system 110 and communication network 120 communicate over communication link 121. Likewise, communication network 120 and web server 130 are in communication over communication link 131.

Event-driven auto-restoration system 110 comprises a computer system and communication transceiver. Event-driven auto-restoration system 110 may also include other components such as a router, server, data storage system, and power supply. Event-driven auto-restoration system 110 may reside in a single device or may be distributed across multiple devices. Event-driven auto-restoration system 110 may be a discrete system or may be integrated within other systems—including other systems within communication system 100. Event-driven auto-restoration system 110 could comprise a network switch, router, switching system, packet gateway, network gateway system, Internet access node, network server, database system, service node, firewall, or some other communication system—including combinations thereof. In some examples, event-driven auto-restoration system 110 could operate as a standalone system outside the infrastructure and firewall of web server 130, or could operate entirely within the infrastructure of web server 130, in which case communication network 120 could comprise a simple, direct communication link or bus between event-driven auto-restoration system 110 and web server 130. In other examples, event-driven auto-restoration system 110 could comprise components both within web server 130 and external to web server 130.

Furthermore, event-driven auto-restoration system 110 can be implemented and deployed in a variety of ways, including but not limited to the embodiments listed below. In one embodiment, event-driven auto-restoration system 110 could operate as a stand-alone and self-contained system (i.e., a centralized implementation). In this embodiment, event-driven auto-restoration system 110 could be deployed externally from web server 130 that hosts the website, and could provide services in the Software as a Service paradigm. Under these circumstances, event-driven auto-restoration system 110 would typically have the necessary credentials for authentication and access to web server 130, such as a username and password, and could automatically take action to restore the website. In another embodiment, event-driven auto-restoration system 110 could run within the same infrastructure that hosts the website, such as within web server 130. In another embodiment, event-driven auto-restoration system 110 may be implemented across several different devices in a distributed manner (i.e., a distributed system). In yet another embodiment, event-driven auto-restoration system 110 could consist of a central device(s) or server(s) and light-weight client agents that are deployed on the devices of users, including personal computers, laptops, smartphones, portable devices, and tablets (i.e., client-server operation). Under this embodiment, event-driven auto-restoration system 110 may operate through a client-server and/or peer-to-peer mode of operation where the website assessment is performed at one time by some part of event-driven auto-restoration system 110 executed on one device, and the results are stored at a centralized or distributed database. Subsequently, the light-weight clients could operate as agents and send commands and user preferences to event-driven auto-restoration system 110. In another embodiment, event-driven auto-restoration system 110 could comprise a stand-alone advisory system that is queried through a specified interface, while in another embodiment, event-driven auto-restoration system 110 may be integrated within a larger security or advisory system.

Communication network 120 could comprise multiple network elements such as routers, gateways, telecommunication switches, servers, processing systems, or other communication equipment and systems for providing communication and data services. In some examples, communication network 120 could comprise wireless communication nodes, telephony switches, Internet routers, network gateways, computer systems, communication links, or some other type of communication equipment—including combinations thereof. Communication network 120 may also comprise optical networks, asynchronous transfer mode (ATM) networks, packet networks, local area networks (LAN), metropolitan area networks (MAN), wide area networks (WAN), or other network topologies, equipment, or systems—including combinations thereof. Communication network 120 may be configured to communicate over metallic, wireless, or optical links. Communication network 120 may be configured to use time-division multiplexing (TDM), Internet Protocol (IP), Ethernet, optical networking, wireless protocols, communication signaling, or some other communication format—including combinations thereof. In some examples, communication network 120 includes further access nodes and associated equipment for providing communication services to several computer systems across a large geographic region.

Web server 130 comprises a processing system and communication transceiver. Web server 130 may also include other components such as a router, server, data storage system, and power supply. Web server 130 may reside in a single device or may be distributed across multiple devices. Web server 130 may be a discrete system or may be integrated within other systems—including other systems within communication system 100. Web server 130 hosts at least a portion of a website. In some examples, web server 130 could comprise a network switch, router, switching system, packet gateway, network gateway system, Internet access node, application server, database system, service node, firewall, or some other communication system—including combinations thereof.

Communication links 121 and 131 use metal, air, space, optical fiber such as glass or plastic, or some other material as the transport medium—including combinations thereof. Communication links 121 and 131 could use various communication protocols, such as TDM, IP, Ethernet, telephony, optical networking, hybrid fiber coax (HFC), communication signaling, wireless protocols, or some other communication format—including combinations thereof. Communication links 121 and 131 could be direct links or may include intermediate networks, systems, or devices.

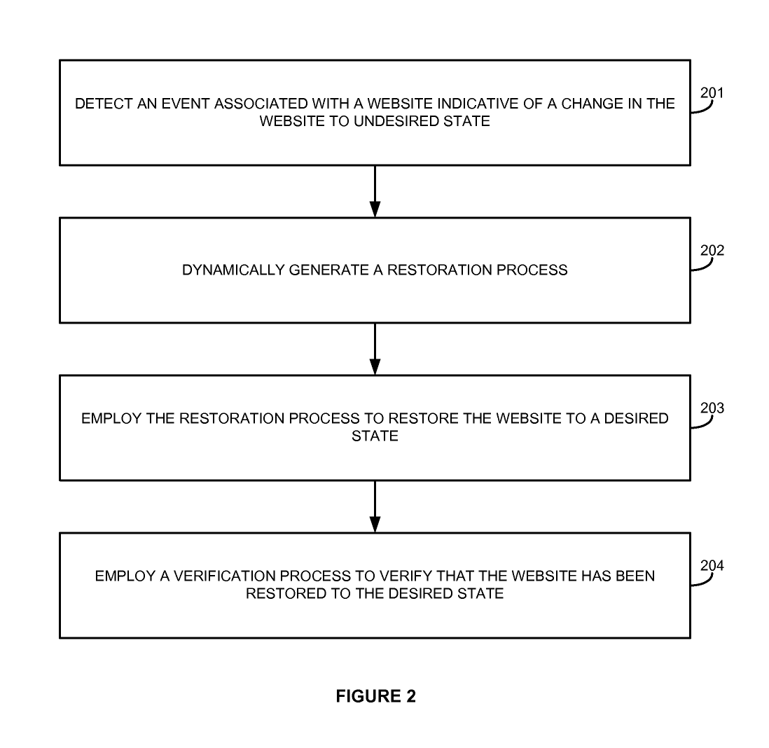

FIG. 2 is a flow diagram that illustrates an operation of communication system 100. The steps of the operation are indicated below parenthetically. Initially, event-driven auto-restoration system 110 detects an event associated with a website indicative of a change in the website to an undesired state (201). The undesired state of the website indicated by an event associated with the website could be defined in many ways, but is typically defined by the detected events themselves, which could be identified by the website owner and/or by predetermined default events detectable by event-driven auto-restoration system 110. For example, an owner of a web site could define what changes in the website are considered undesirable by selecting which events associated with the website should be detected by event-driven auto-restoration system 110.

The event or events associated with the website could comprise any occurrence detectable by event-driven auto-restoration system 110 associated with a change in a state of the website. For example, the event could comprise a decline in reputation of the website, such as a decline in a reputational ranking of the website by an external system or an identification of how the web site is being displayed in search results by search engines, including a change in ranking by the search engine or a change in a display position in search results. In addition, the event could comprise the blacklisting of the website by an external system or a blacklisting of the IP address and/or domain at which the website is hosted, a modification to the code of the website, a malware attack or detection of undesirable code or content appearing on the website, a complaint about the web site from a visitor of the website, and other events indicative of a change in the website to an undesired state. In some examples, the user could specify a time period during which changes to the source code of the website are scheduled, along with restoration preferences in the event that changes to the website are detected by event-driven auto-restoration system 110 outside of the scheduled time period. Further, event-driven auto-restoration system 110 could submit queries to search engines with predetermined and/or user-selected keywords and search terms deemed “undesirable” to test if the website is included in search results using these terms, which could indicate that the website has been compromised and a hacker has injected false or misleading keywords into pages of the website. In addition, the event could simply comprise a request to employ a restoration process to the website made on behalf of the website owner, operator, system administrator, or some other entity associated with the website.

In order to detect the event, event-driven auto-restoration system 110 monitors a current state of the website, analyzes historical events associated with the website, and considers external information associated with entities that are external to event-driven auto-restoration system 110 and/or web server 130. Each of these categories of information (i.e., current state, historical events, and external information) that are used by event-driven auto-restoration system 110 to detect the event are addressed individually in the discussion below.

To monitor the current state of the website, event-driven auto-restoration system 110 processes content information associated with the website describing the current state of the website. Typically, event-driven auto-restoration system 110 receives the content information from web server 130 that hosts the website, but event-driven auto-restoration system 110 could receive the content information from a database, server, local disk, or some other communication system (not shown). The content information could comprise a variety of factors and attributes associated with the content accessible at the website. For example, the content information could include network characteristics of web server 130, such as round trip delay, available bandwidth, and IP-level characteristics, such as IP space and identification of a domain name system (DNS) resolver that translates the website domain name into an IP address. The content information could also include the textual content of the website that is stored in web server 130, including keywords, word count, metadata, and semantic meanings of text appearing in the website. The content information could also include the actual website code, including the format of the code, programming languages utilized, such as hypertext markup language (HTML), PHP, Perl, and JavaScript, known weaknesses and exploitabilities of each of the languages, the programming style, and the like. In some examples, the programming style could be further analyzed to determine any deviations from best coding practices and specifications. The content information could also comprise characteristics of any kind of software associated with the website.

In addition to the website code, the content information could also include all content and web objects of the website, including shockwave files, flash animation, images, executables, audio, video, portable document format (PDF) files, and the like. The content information could also include content provided by third-party entities, such as advertisements appearing on the website that are controlled and hosted by a separate web server other than web server 130. In some examples, the content information could comprise characteristics of a server that hosts the website, such as web server 130. Such server characteristics could include the type of hardware and software of web server 130, such as a motherboard, processor, storage devices, operating systems, firewalls, and other software and equipment associated with web server 130 that hosts the website. Further, the content information could include these same types of server characteristics for other servers that supply third-party content appearing on the website, such as servers that provide advertisements for display on the website.

Additional data that may be included in the content information could comprise characteristics of the infrastructure of the business or individual that owns and operates the website, geographical characteristics of the website, and various security characteristics of the website, including security certificate analysis, security holes which are or have been present in the website, vulnerabilities identified by penetration testing tools, and other security issues. In some examples, the content information could include characteristics of any products, services, and/or information that is sold, transferred, or available via the website. Additionally, the content information could comprise associations of other pages and websites that link to or are linked from the website to form a map of interconnected pages between the other websites and the website being analyzed. In some examples, the content information could also include information about various mechanisms that a user may utilize to interact with the website, such as web forms, Completely Automated Public Turing tests to tell Computers and Humans Apart (CAPTCHAs), rate limiting policies, different language versions of the website, and others. The above represents only a small sampling of the type of data that may be included in the content information, and one of skill in the art will understand that additional data and metrics may be included in the content information for the website.

In addition to monitoring the current state of the website as discussed above, event-driven auto-restoration system 110 also processes historical event information associated with the website for use in detecting the event associated with the website indicative of a change in the website to an undesired state. The historical event information could be received from web server 130 and/or other communication systems external to web server 130. The historical event information comprises past behavior and historical information associated with the website. In some examples, the historical event information could comprise frequency of content changes of the website, frequency of security attacks on the website by malicious entities, and frequency of changes to a hosting infrastructure of the website, such as changes affecting the computer and network infrastructure that supports the site. The historical event information could include trends of events on similar types of websites, profiles of customer base, role, and traffic associated with the website, characteristics of the staff or companies managing the website or parts of its functions and infrastructure, along with whether or not an active website protection service is utilized. The historical event information could also include the reputation of a professional webhosting company that hosts the website, such as web server 130. Additionally or alternatively, the historical event information could include the historical presence of the website in blacklists, including the specific IPs and web hosting providers, such as web server 130, associated with problems that led to the blacklisting. Other data and historical metrics could be included in the historical event information; the above merely provides examples of the type of data that may be included in the historical event information.

Further, event-driven auto-restoration system 110 processes external information associated with the website from sources external to the website for use in detecting the event associated with the website. Typically, event-driven auto-restoration system 110 would receive the external information from communication systems, servers, and databases that are not associated with web server 130. In some examples, the external information could comprise blacklists for the domain name and/or the IP of the website, including metrics associated with the blacklisting, such as duration of time spent on the blacklist, frequency of blacklisting, and the reasons for blacklisting. In addition, the external information could include blacklists of external IP addresses known for distributing spam/adware, spyware, viruses, and other malware, and IP addresses associated with website infiltrations and hacking attempts, such as distributed denial of service attacks and other malicious activities. The external information could also include trends of events on similar types of websites, where similarity is based on factors including infrastructure, reputation, type of business, and other attributes. The external information could further include a reputational ranking of the website by search engines, indexing services, and other web servers. In some examples, the external information could include a community ranking of the website, such as collective opinions about the reputation of the website gleaned from individual posts, votes, and/or other interactions with the public on weblogs, online forums and the like. In addition, the external information could comprise community-driven efforts such as the Web of Trust and other website reputation rating tools where members of the community rank individual websites according to their user experience and other factors. Additional external information is also possible and within the scope of the present disclosure.

Event-driven auto-restoration system 110 processes the content information, historical event information, and external information to detect the event associated with the website indicative of a change in the website to an undesired state. In some examples, to detect the event associated with the change in the website, event-driven auto-restoration system 110 could process the content information, historical events, and external information in a hierarchical arrangement and apply a mathematical framework using both weighted functions and by continuously adapting weights to each item of information included in this data. The adaptable weights for each of the data items could be predetermined or initially set by a user, and then dynamically modified based on changes in the underlying data and other factors, such as the relative weights of each of the other data items in the content information, historical event information, and external information. In some examples, to process the content information, historical event information, and external information to detect the event associated with the website, event-driven auto-restoration system 110 could utilize mathematical tools for prediction and estimation, such as maximum likelihood, Bayesian theory, neural networks, machine learning techniques, and other methods. Further, this approach is customizable and may be slowly trained and fine-tuned over time via a machine learning process based on input and feedback from the operator of the system to detect the event or events indicative of the undesired state of the website.

In some examples, a numerical scoring system could be used to reflect the level of severity of the detected event, which could consider the respective weights of each of the items in the data. The scores for each of the data items could then be compared to baseline or threshold values for each respective item to determine the extent to which a particular data item will influence an overall score indicative of the severity of the detected event. The score could reflect characteristics of the website across one or more dimensions including safety, privacy, trustworthiness, reliability, business ethics, customer feedback, infrastructure reputation, historical security events, and others. Moreover, in some examples, event-driven auto-restoration system 110 could assess a trustworthiness of the external information based on a reputation of the source of the external information. In such examples, event-driven auto-restoration system 110 could include the trustworthiness of the external information as a factor when determining the score for the event associated with the website. For example, event-driven auto-restoration system 110 could apply adaptable weights to each data item of the external information based on their individual trustworthiness levels, and then dynamically modify the weights based on updated trustworthiness determinations. The weights for each of the data items in the external information could then be compared to threshold values for each respective item to determine the extent to which a particular data item will influence the score.

Upon detecting the event associated with the website indicative of a change in the website to an undesired state, event-driven auto-restoration system 110 dynamically generates a restoration process (202). The restoration process that event-driven auto-restoration system 110 dynamically generates could be based on many factors, including predetermined restoration techniques depending on the particular event and/or type of event detected, along with user preferences provided by an owner or other entity associated with the website. For example, event-driven auto-restoration system 110 could generate a restoration process that removes offending pages, portions of source code, advertisements, or other content deemed undesirable by the website owner and/or event-driven auto-restoration system 110. In another example, instead of removing the undesirable content, event-driven auto-restoration system 110 could replace the offending content with non-empty dummy content, which could be provided by the owner of the website, or could comprise predetermined default replacement content based on the original content of the website, the type of the website, and other factors associated with the website. Additionally, event-driven auto-restoration system 110 could dynamically generate replacement content, such as search engine optimized (SEO) keywords, images, notices, and other information based on the original website, including the type or category associated with the website and the original content appearing on the website.

The restoration process generated by event-driven auto-restoration system 110 could also comprise a restoration of the entire website from a previous backup, which could be provided by the website owner and/or automatically stored by event-driven auto-restoration system 110. Additionally, specific web pages, portions of source code, and other content appearing on the website could be restored piecemeal from the previous backup, which could be applied automatically if the state and structure of the website has not changed significantly from the state of the backup as defined by a threshold level of change. Such piecemeal restorations of portions of the website from backups could be verified by an intelligent algorithm using breadth-first search or other techniques. Moreover, when multiple backup versions are available, such as when event-driven auto-restoration system 110 stores and/or can access a daily backup of the website, the website owner could specify which backup or website version should be used for each portion of content that is restored from these backups.

Furthermore, event-driven auto-restoration system 110 could remove or replace offending portions of the source code at different levels of granularity, which could be selected based on default values and/or based on user preferences, the type of event detected, and other factors. For example, event-driven auto-restoration system 110 could employ line-level removal or replacement of only the offending lines of source code associated with the detected event. In another example, event-driven auto-restoration system 110 could remove or replace only the offending characters, words, hyperlinks and/or commands associated with the detected event. Additionally, event-driven auto-restoration system 110 could remove or replace web objects and/or their associated source code, such as image files, PDF documents, hyperlinks, flash animations, shockwave content, and the like. Further, instead of removing the offending web objects, event-driven auto-restoration system 110 could attempt to cleanse these web objects of the offending content by recursively invoking the removal of identified lines of code associated with a web object. For all of the restoration processes described above, event-driven auto-restoration system 110 could identify the offending or malicious content that is associated with the detected event using an appropriate set of inference functions and the use of machine learning algorithms and other techniques that may be trained and refined for optimized performance and detection accuracy.

In addition to the above, event-driven auto-restoration system 110 could generate the restoration process by redirecting visitors and search engine crawlers to an alternate website. In some examples, the alternate website could comprise a temporary backup copy of a previous state of the website that does not contain the undesirable content that triggered the detected event. This approach is typically a temporary measure that remains in effect until the actual website is fully restored in an effort to help prevent damage to the reputation of the website, unwanted spread of malware infections, and other negative consequences of the undesirable state of the website. In some examples, the website owner can choose to enable or disable this feature, and can further specify the location of the temporary website to be used for the redirection.

Event-driven auto-restoration system 110 could also generate the restoration process by implementing a migration to a new IP address and/or hosting entity, such as by moving the website from web server 130 to an alternate web server. In some examples, event-driven auto-restoration system 110 could generate this restoration process as a precaution accompanying a blacklisting event of the website name, when the IP address that hosts the website is deemed undesirable based on blacklisting of the IP address or some other decline in reputation of the hosting entity, and/or in combination with user preferences or direct requests to migrate the website away from the present host. This migration process could involve invoking an automated process to migrate the website to a new host machine, which could be physical or virtual, or could involve creating a request to instruct the appropriate tool or user to effectuate the migration. Such a request for website migration could be provided in any form, including an email, short message service (SMS) text message, or a specialized alert, and could be integrated into a larger website management system or provided as a standalone notification.

Once the restoration process has been dynamically generated, event-driven auto-restoration system 110 employs the restoration process to restore the website to a desired state (203). Event-driven auto-restoration system 110 can deploy an array of different techniques and actions based on the specific event or events detected by event-driven auto-restoration system 110 and user specifications provided by the website owner. Thus, depending on the restoration process generated, event-driven auto-restoration system 110 implements and executes one or more of the above restoration processes in order to restore the website to the desired state. In some examples, event-driven auto-restoration system 110 could automatically restore a website based on a threshold decline of a reputation of the website, and could employ any of the above restoration processes in doing so.

Event-driven auto-restoration system 110 employs a verification process to verify that the website has been restored to the desired state (204). To verify the desired state of the restored website, event-driven auto-restoration system 110 examines the website using tools and techniques similar to those described above for detecting the event associated with the website in operation 201. The verification process employed by event-driven auto-restoration system 110 could include invoking several functions and analyzing a variety of metrics. For example, event-driven auto-restoration system 110 could “crawl” the website by accessing and parsing the entire website, similar to a search engine crawler, in order to ensure that the website is reachable in its entirety, which could include assessing whether all of the pages that were present in the previous version of the website are still reachable by counting the total number of pages in the restored website. Further, event-driven auto-restoration system 110 could verify that the website does not contain errors or missing pages and content, which could be accomplished by comparing the restored version of the website to backup copies and/or baseline versions of the website. As part of the verification process, event-driven auto-restoration system 110 could also check the restored version of the website for malicious code and/or embedded malicious hyperlinks. Event-driven auto-restoration system 110 could also check for broken and/or missing hyperlinks based on a backup copy or previously verified version of the website and assess whether or not the previous version also had these broken and/or missing hyperlinks. In some examples, event-driven auto-restoration system 110 could also check the reputation of the website, including an assessment of the current page rank of the website according to various search engines and other web site ranking systems, along with SEO parameters and other metrics. Further, event-driven auto-restoration system 110 could ensure that the restored website exhibits an acceptable response time for page requests as determined by previous page loading benchmarks for the website, industry standards, network capabilities, user preferences, or some other response time thresholds, along with the overall performance of the website and its associated web objects and other applications. In some example, the verification process could also comprise ensuring appropriate functionality and expected behavior of the website. Other verification techniques are also possible.

Any or all of the above verification processes could be specified according to user preferences provided by the website owner, providing a completely adaptable and customizable system to suit the needs of any particular website. The outcome of the verification process could also trigger further action by event-driven auto-restoration system 110. For example, if event-driven auto-restoration system 110 verifies that the website has been restored to the desired state, event-driven auto-restoration system 110 may notify the website owner or other entities associated with the website that the website has been successfully restored and verified, which again could occur according to specified user preferences. Additionally, in some examples, the outcome of the verification process could trigger a second restoration process to restore the website to the desired state, and a second verification process could then be employed to verify that the website has been restored to the desired state. For example, if employing the first restoration process involved restoring a portion of code associated with the website, which subsequently fails the verification process, then event-driven auto-restoration system 110 could dynamically generate and employ a second restoration process that comprises restoring the website to a previous version of the website using an entire backup of the website. Event-driven auto-restoration system 110 could then verify that the website has been restored to the desired state by employing a second verification process, which could be different from the first verification process. In this manner, event-driven auto-restoration system 110 could employ this iterative approach multiple times until the desired state of the website is restored and verified.

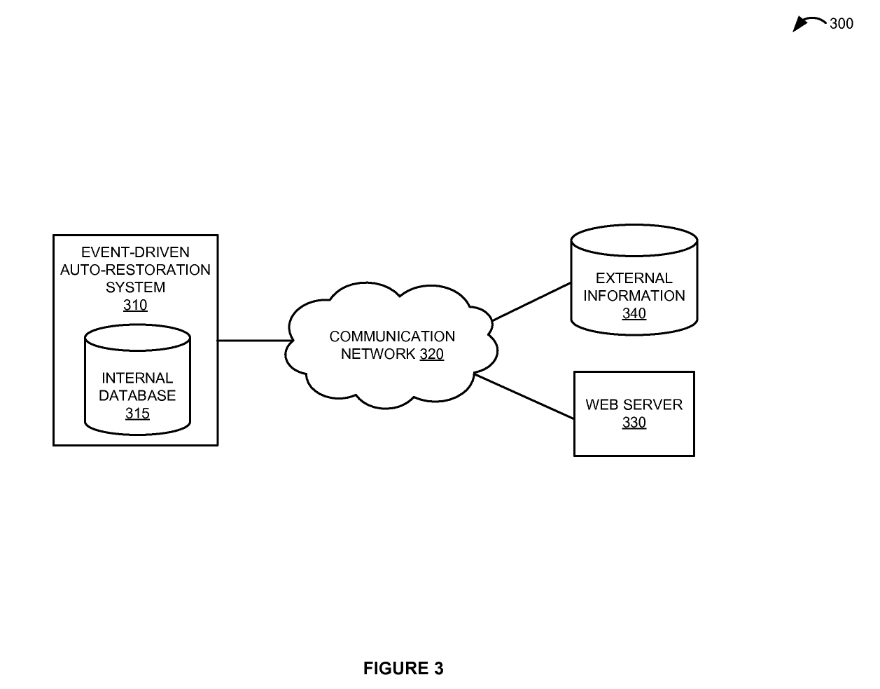

Advantageously, event-driven auto-restoration system 110 protects the reputation of a website by automating, facilitating, and rapidly detecting an event indicative of an undesired state of a website and subsequently restoring the website and verifying the effectiveness of the restoration process. By actively monitoring for and reacting to undesirable states of a website, event-driven auto-restoration system 110 can help ensure that the website is not blacklisted by search engines and security entities, that site visitors are not compromised or misled by malicious code that may have been secretly embedded into the website, and that the operation of the website is minimally disrupted and its functionality remains at desired levels. Further, the factors and other items of information used by event-driven auto-restoration system 110 to detect the event indicative of the undesired state, dynamically select and employ the restoration process, and the subsequent verification processes could be selectively included, excluded, or weighted by the user for a fully parameterized and fine-tuned assessment and restoration of a website. An exemplary embodiment involving such user customization will now be discussed with respect to FIGS. 3, 4, and 5.

FIG. 3 is a block diagram that illustrates communication system 300 in an exemplary embodiment. Communication system 300 includes event-driven auto-restoration system 310, communication network 320, web server 330, and external information 340. Event-driven auto-restoration system 310 includes internal database 315. Web server 330 and external information 340 are in communication with event-driven auto-restoration system 310 via communication network 320.

Web server 330 comprises the primary web host for a website to be monitored, and in this example, event-driven auto-restoration system 310 has all the necessary parameters and credentials for accessing all of the source code and other content of the website from web server 330, which could be subsequently stored in internal database 315. Internal database 315 also stores backups of the entire website. Additionally, internal database 315 stores historical event information associated with the website, information associated with the current business practices of the website operator, and includes the policies and practices used to maintain the website and related infrastructure. Further, internal database 315 stores information related to trends over different types or categories of websites, which can be used by event-driven auto-restoration system 310 to detect similar trends that may be expected to occur for similar types of websites. External information 340 supplies information associated with the website that is external to the website being analyzed, which could comprise publically-available and/or third-party metrics, opinions, test results, and other data associated with the website. External information 340 could also include additional content that appears and/or is linked on the website hosted by a third-party host that is external to web server 330, such as advertisements, external hyperlinks, and other content not hosted by the primary web server 330. Note that although external information 340 is shown as a single entity, in practice external information 340 is typically provided from multiple servers and systems in geographically diverse locations. One of skill in the art will understand that the system and network architecture shown in the exemplary embodiment of communication system 300 is just one of many possible examples of how event-driven auto-restoration system 310 could be implemented and could receive the various items of information necessary to monitor, restore, and verify a website.

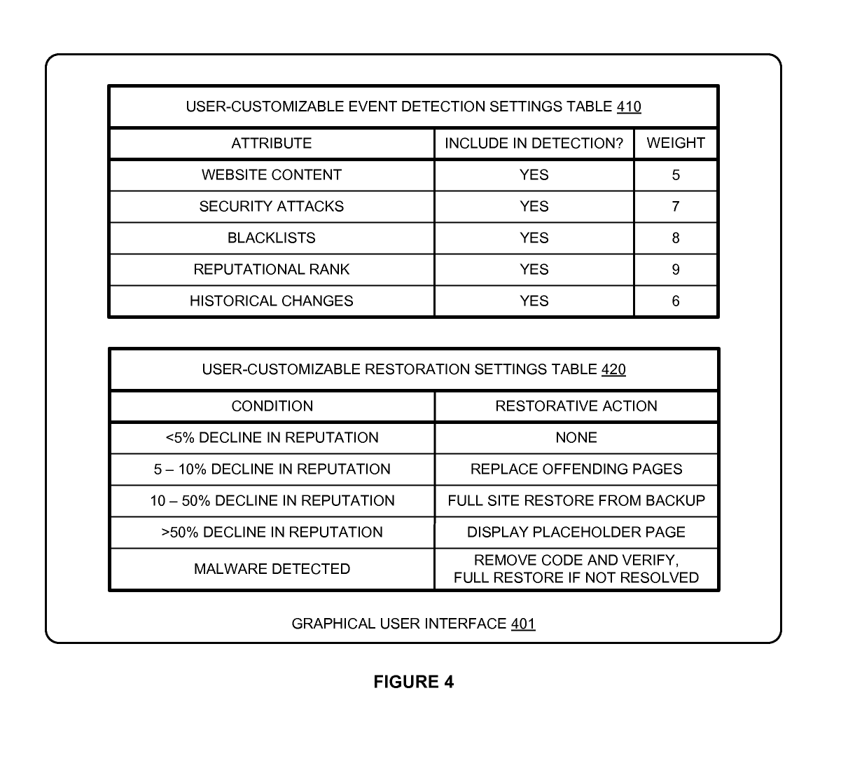

FIG. 4 is a block diagram that illustrates graphical user interface 401 in an exemplary embodiment. Graphical user interface 401 provides an example of a user-customizable event detection settings table 410 that may be used to provide input for various options associated with detecting events indicative of an undesired state of a website, and an example of a user-customizable restoration settings table 420. The user-customizable event detection settings table 410 shown on graphical user interface 401 could be presented to the user via a web browser, such as a website where the user may provide selections for the security analysis using form entry boxes, dropdown menus, radio buttons, and the like. Alternatively, the user could provide the input via a standalone application executed on a computer system or some other device capable of displaying various options and receiving input selections from the user. In order to select the website to be analyzed, the user could provide the website directly by typing a uniform resource locator (URL) of the website, by clicking or hovering a mouse cursor over a hyperlink appearing on another website being viewed by the user, based on the URL of the website currently being viewed by the user, by examining embedded hyperlinks in a website being viewed by the user, or some other manner of indicating a website to event-driven auto-restoration system 310.

Once the website is identified to the system, the user can customize and fine-tune the monitoring and event detection settings for the website by providing additional parameters pertaining to the desired level of detail, the number and type of sources of information or tools for use in the event detection, and a weighting for each of the selected attributes. In this example, the user can provide these preferences using the user-customizable event detection settings table 410. The table 410 includes columns labeled “Attribute”, “Include in Detection?”, and “Weight”. Each of the various attributes and parameters associated therewith may be selected by a user, such as a website owner, for inclusion or exclusion from the event detection of the website. One of skill in the art will understand that the various attributes and configuration options appearing on the user-customizable event detection settings table 410 are merely exemplary in nature, and that other examples could include greater or fewer attributes and columns of information presented to the user along with greater or fewer selections and preferences provided by the user, including finer or coarser levels of granularity for the attributes and user selections.

The “Attribute” column shown on table 410 indicates various information types and factors that may be used by event-driven auto-restoration system 310 in detecting an event associated with a website. In this example, the user may select whether or not individual attributes are included in the detection process, and can apply a weight to each of the attributes to indicate a level of importance of each of the attributes that will be used by event-driven auto-restoration system 310 when monitoring the website and detecting events that are indicative of an undesired state of the website. The exemplary embodiment of FIG. 4 uses a weighting scale of 1 to 10, although the weights for each attribute could be provided using alternative scales or systems in other examples.

In this example, the user has entered selections for the various attributes on graphical user interface 401. As shown in table 410, the user has assigned a weight of “5” to the “website content” attribute, a weight of “7” to the “security attacks” attribute, a weight of “8” to the “blacklists” attribute, a weight of “9 to the “reputational rank” attribute, and a weight of “6” to the “historical changes” attribute. Thus, the user in this example is primarily concerned with the reputation of the website, and has accordingly weighted the “reputational rank” and “blacklists” attributes higher than the other attributes in order to fine-tune event-driven auto-restoration system 310 for strong reputational protection of the website. In this manner, the event detection may be fully customized, and these attributes and respective weightings are also adaptive and can evolve using machine learning algorithms and user feedback over a period of time to continuously improve on the effectiveness and accuracy of the system. These same settings could also be applied to the verification process, or the user could specify alternative attributes and/or weightings for event-driven auto-restoration system 310 to use in verifying the website after applying a restoration process.

As shown on graphical user interface 401, the user has also provided various preferences for event detection and restoration of the website on the user-customizable restoration settings table 420. Table 420 includes columns labeled “Condition” and “Restorative Action”, which define various events that may be detected by event-driven auto-restoration system 310 and the restoration process desired by the user associated with each respective condition.

In this example, the user has indicated that if event-driven auto-restoration system 310 detects less than a 5% decline in the reputation of the website, no restorative action should be taken. However, if event-driven auto-restoration system 310 detects a decline in the reputation of the website in the range of 5 to 10%, event-driven auto-restoration system 310 should generate and employ a restoration process that replaces the offending pages that event-driven auto-restoration system 310 determines are associated with the reputational decline. Likewise, if event-driven auto-restoration system 310 detects a decline in reputation of 10 to 50%, event-driven auto-restoration system 310 should fully restore the website from a previous backup. If event-driven auto-restoration system 310 detects greater than a 50% decline in reputation, event-driven auto-restoration system 310 should replace the entire website with a simple placeholder page that displays a message specified by the user, such as “Sorry for the inconvenience, the system is undergoing scheduled maintenance” or the like.

Finally, if event-driven auto-restoration system 310 detects the presence of malware on the website, event-driven auto-restoration system 310 should first attempt to remove the offending portions of the source code that are determined to be associated with the malware and verify the restorative action, and if the problem is not fully resolved, then event-driven auto-restoration system 310 should perform a full restoration of the website from a backup version. Although not shown on FIG. 4, when the user selects a restorative action that involves replacing the entire website or any portion thereof from a backup, the user could additionally specify a particular backup version for use in the restoration, such as by date and time, version number, or some other identification method. Further, the user could specify that if the particular version selected fails to remedy the problem, an older backup version should be used in a subsequent restoration attempt.

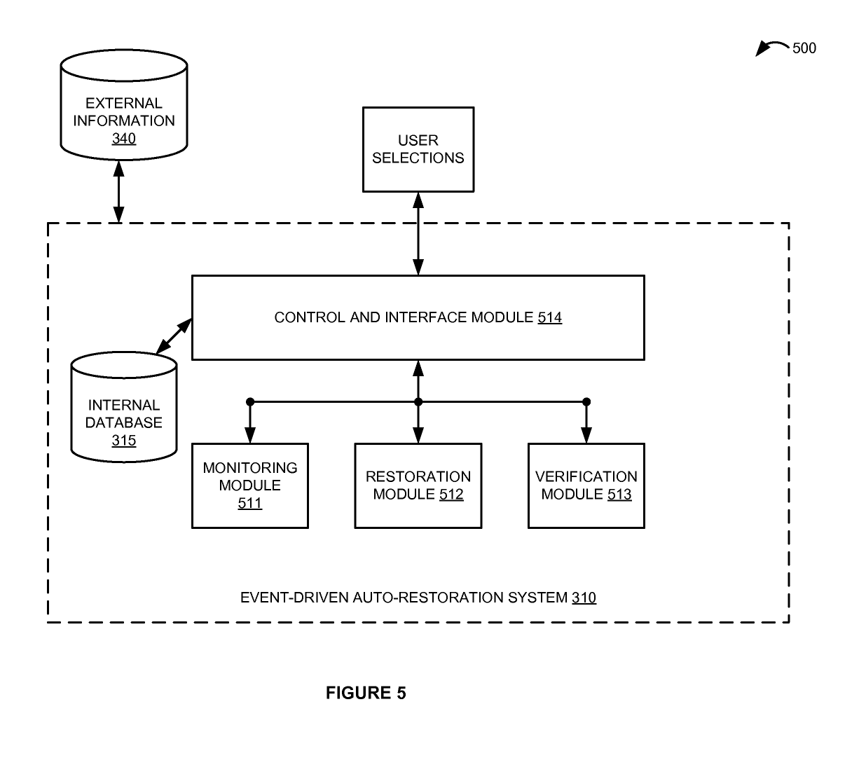

FIG. 5 is a block diagram that illustrates an operation of communication system 300 in an exemplary embodiment. In particular, the user selections shown in FIG. 4 are provided as input to the control and interface module 514 of event-driven auto-restoration system 310. In FIG. 5, event-driven auto-restoration system 310 is shown as comprising monitoring module 511, restoration module 512, verification module 513, control and interface module 514, and internal database 315. Event-driven auto-restoration system 310 also has access to external information 340 over communication network 320. Event-driven auto-restoration system 310 provides an example of event-driven auto-restoration system 110, although system 110 could use alternative configurations.

In this example, after the user selections are input into event-driven auto-restoration system 310 via graphical user interface 401 using control and interface module 514 (which could be performed remotely by the user via a web browser or some other client application), the various attributes and weights are provided to monitoring module 511 for processing and event detection. In particular, monitoring module 511 retrieves website content information from web server 330 along with any additional content from external information 340 that appears on the website but is not hosted by web server 330. Monitoring module 511 processes this information to detect events indicative of undesirable changes to the website. In doing so, monitoring module 511 may execute a variety of software-based tools to collect and analyze the information, including tools that detect network infrastructure vulnerabilities, penetration testing tools, structured query language (SQL) injection tools, malware/virus detection tools that can identify the presence of malicious code on a website, and other software applications. In this example, a weight of “5” has been assigned to the “website content” attribute, which could include the type of hardware and software used by web server 330, such as a type of web server software utilized, software version/update status, an operating system executing on the server 330, and other server characteristics. Additionally, the “website content” attribute could include the code that comprises the website, including the format, the language, the programming style, the weaknesses of each type of programming language used in the code, an identification of any deviation from standard coding practices and specifications, and other characteristics of the programming languages used to create the website. Furthermore, event-driven auto-restoration system 310 could consider the characteristics of the infrastructure of the business which owns and operates the website, characteristics of any products, services, and information that are sold, offered, or available at the website, and other characteristics of the website as part of the “website content” attribute. Monitoring module 511 compiles all of this information and applies a mathematical framework to the event detection analysis, including the weight of “5” selected by the user as shown in table 410.

In addition to the website content, monitoring module 511 retrieves external information from external information 340 and historical event information from internal database 315 and/or web server 330. As shown in FIG. 4, the user has weighted the attributes of “blacklists” and “reputational rank” relatively higher than the other attributes to emphasize reputational protection for the website. In particular, the “security attacks” attributes has been assigned a weight of “7”, the “blacklists” attribute a weight of “8”, the “reputational rank” attribute a weight of “9”, and the “historical changes” attribute is weighted “6”. Monitoring module 511 thus processes this information and applies the respective weights to each attribute when determining which detected events are indicative of an undesired state of the website. The various weighted attributes are then combined based on a weighted sum model which is derived from analyzing the effect of various weights on the accuracy of detecting events indicative of undesirable states of a website. The weighted sum model could be based on predictive Markov models and regression-based mathematical modeling to probabilistically predict the appropriate weights to use when combining all of the attributes in order to provide an accurate result. In some examples, monitoring module 511 could use adaptive machine learning and feedback mechanisms from the operator or a training set in order to intelligently assess the trustworthiness of the external information 340, and could then factor in this trustworthiness component when applying the weights to the various attributes that are based on information obtained from external information 340, which could result in modifications to the weights that were selected for these attributes by the user in table 410.

Control and interface module 514 controls the operation of event-driven auto-restoration system 310 by taking the inputs to the monitoring module 511, such as the content information, current state of the website, historical events, and external information, and combining them with the user inputs and specifications provided on graphical user interface 401. Control and interface module 514 is responsible for invoking restoration module 512 when monitoring module 511 detects an event associated with an undesirable state of the website, and subsequently invokes the verification module 513 to verify that the website has been restored to a desired state. Further, control and interface module 514 may repeatedly invoke the restoration module 512 and the verification module 513 in an iterative fashion until the verification module 513 determines that the website has been successfully restored to the desired state.

After an event that is indicative of an undesirable state of the website is detected by monitoring module 511, control and interface module 514 invokes restoration module 512, which takes active steps to dynamically generate a restoration process and employs the restoration process to restore the website to a desired state. The selection of which techniques should be used for the restoration includes intelligent and adaptive decision logic that factors in the type of malware detected, if any, the type of hacking incident, the type of website in terms of size, complexity, services provided, and the like, and the preferences and priorities defined by the user. Further, to determine the restoration process, restoration module 512 could utilize mathematical tools for prediction and estimation, such as maximum likelihood, Bayesian theory, neural networks, machine learning techniques, weighted decision trees, and other methods.

In this example, the user has provided restoration preferences as shown in user-customizable restoration settings table 420 of FIG. 4. The conditions defined in table 420 could be used by monitoring module 511 to determine which events are indicative of an undesired state of the website, and could also be used by restoration module 512 to dynamically generate a restoration process for a particular event detected by monitoring module 511. Further, the user has provided restorative actions to be taken by event-driven auto-restoration system 310 for each respective condition. Restoration module 512 processes these user preferences and selections along with different restoration techniques depending on the specifics of the situation and the type of event detected by monitoring module 511 to dynamically generate a restoration process for the website. Restoration module 512 then employs the generated restoration process in an attempt to restore the website to a desired state.

After restoration module 512 restores the website to the desired state, control and interface module 514 invokes verification module 513 to verify that the website was restored to the desired state. Verification module 513 verifies the operation and functionality of the website by examining the website with tools and techniques similar to those described above for monitoring module 511. The outcome of each verification attempt is used by event-driven auto-restoration system 310 to determine whether the current state of the website is acceptable or whether another restoration process should be selected and invoked.

Additionally, the outcome of verification module 513 could be communicated to the owner, administrator or some other entity of the website according to specified preferences. To communicate the verification results, event-driven auto-restoration system 310 organizes and presents the information at the appropriate level of detail, which may be specified by a user of event-driven auto-restoration system 310. In some examples, event-driven auto-restoration system 310 considers the preferences of the recipient of the information, the authorized level of detail for the recipient, and other factors. The recipient of the information could comprise another computer system or software application in some examples. Event-driven auto-restoration system 310 is capable of formatting the output of verification module 513 and other results in a variety of ways, including numerical values, letters, symbols, strings, sounds, and graphics, such as colors, plots, and charts.

In addition, event-driven auto-restoration system 310 associates the evaluation of the data with various indicators that reflect the depth, availability, specific parameters, and techniques used to produce the results. For example, an indicator could identify that the results are not based on historical event information if the website is new or under development and no historical information exists for the website. In some examples, the information presented to the user could also include suggestions as to actions that may be taken by the website operator in order to improve the safety and security of the website and to prevent the detected event indicative of the undesirable state of the website from occurring again in the future. Event-driven auto-restoration system 310 is thus able to provide an array of results and other information that may be used by a recipient to evaluate the safety and security of the website and to review the events that were detected and the restoration and verification processes that were utilized, with varying levels of detail in the report.

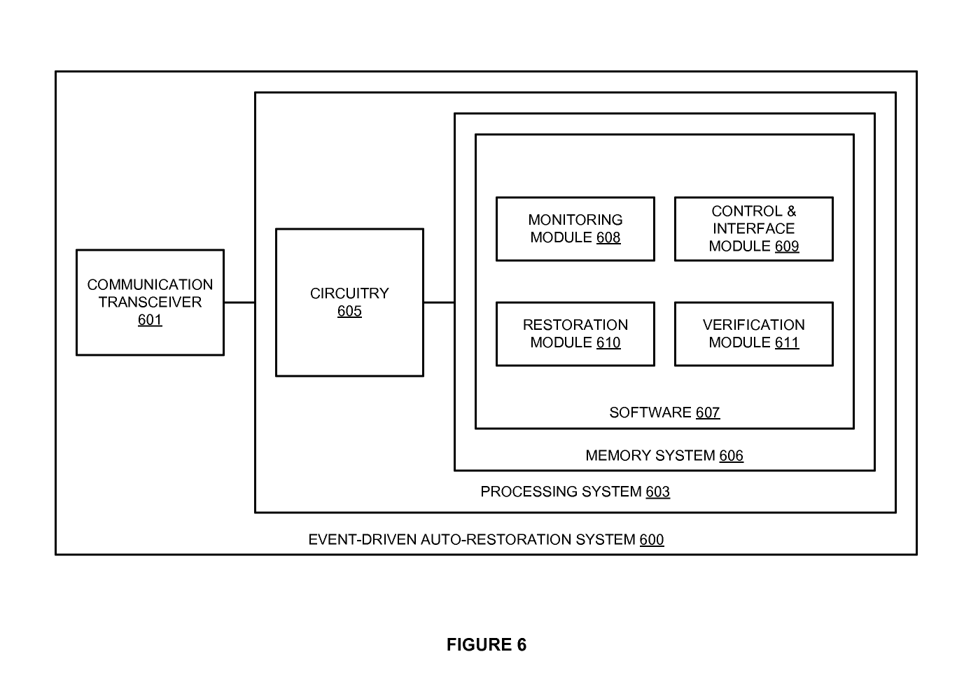

FIG. 6 is a block diagram that illustrates event-driven auto-restoration system 600. Event-driven auto-restoration system 600 provides an example of event-driven auto-restoration systems 110 and 310, although systems 110 and 310 may use alternative configurations. Event-driven auto-restoration system 600 comprises communication transceiver 601 and processing system 603. Processing system 603 is linked to communication transceiver 601. Processing system 603 includes processing circuitry 605 and memory system 606 that stores operating software 607. Operating software 607 comprises software modules 608-611.

Communication transceiver 601 comprises components that communicate over communication links, such as network cards, ports, RF transceivers, processing circuitry and software, or some other communication components. Communication transceiver 601 may be configured to communicate over metallic, wireless, or optical links. Communication transceiver 601 may be configured to use TDM, IP, Ethernet, optical networking, wireless protocols, communication signaling, or some other communication format—including combinations thereof.

Processing circuitry 605 comprises microprocessor and other circuitry that retrieves and executes operating software 607 from memory system 606. Processing circuitry 605 may comprise a single device or could be distributed across multiple devices—including devices in different geographic areas. Processing circuitry 605 may be embedded in various types of equipment. Memory system 606 comprises a non-transitory computer readable storage medium, such as a disk drive, flash drive, data storage circuitry, or some other hardware memory apparatus. Memory system 606 may comprise a single device or could be distributed across multiple devices—including devices in different geographic areas. Memory system 606 may be embedded in various types of equipment. Operating software 607 comprises computer programs, firmware, or some other form of machine-readable processing instructions. Operating software 607 may include an operating system, utilities, drivers, network interfaces, applications, or some other type of software. In this example, operating software 607 comprises software modules 608-611, although software 607 could have alternative configurations in other examples.

When executed by circuitry 605, operating software 607 directs processing system 603 to operate as described herein for event-driven auto-restoration systems 110 and 310. In particular, operating software 607 directs processing system 603 to detect an event associated with a website indicative of a change in the website to an undesired state. Further, operating software 607 directs processing system 603 to dynamically generate a restoration process. Operating software 607 also directs processing system 603 to employ the restoration process to restore the website to a desired state. Finally, operating software 607 directs processing system 603 to employ a verification process to verify that the website has been restored to the desired state.

In this example, operating software 607 comprises a monitoring software module 608 that detects an event associated with a website indicative of a change in the website to an undesired state. In addition, operating software 607 comprises a restoration module 610 that dynamically generates a restoration process and employs the restoration process to restore the website to a desired state. Further, operating software 607 comprises a verification software module 611 that verifies that the website has been restored to the desired state.

In some examples, operating software 607 could further comprise a control and interface software module 609 that invokes restoration software module 610 in response to monitoring software module 608 detecting the event associated with the website indicative of the change in the website to the undesired state, and subsequently invokes verification software module 611 to verify that the website has been restored to the desired state.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating an event-driven auto-restoration system for websites, the method comprising:
detecting an event associated with a website indicative of a change in the website to an undesired state;
dynamically generating a restoration process;
employing the restoration process to restore the website to a desired state; and
employing a verification process to verify that the website has been restored to the desired state.

2. The method of claim 1 further comprising receiving user input specifying sub-processes for inclusion within the restoration process.

3. The method of claim 1 wherein dynamically generating the restoration process comprises dynamically generating the restoration process in response to detecting the event.

4. The method of claim 1 further comprising, if employing the verification process fails to verify that the website has been restored to the desired state, then dynamically generating a second restoration process, employing the second restoration process to restore the website to the desired state, and employing a second verification process to verify that the website has been restored to the desired state.

5. The method of claim 4 wherein employing the restoration process comprises restoring a portion of code associated with the website, and wherein employing the second restoration process comprises restoring the website to a previous version of the website using an entire backup of the website.

6. The method of claim 1 wherein the event comprises a decline in reputation of the website.

7. The method of claim 1 wherein the event comprises artifacts created by a malware attack.

8. The method of claim 1 wherein the event comprises a malfunction of the website, and wherein a cause of the malfunction is unknown when the event is detected.

9. An event-driven auto-restoration system for websites, the system comprising:
a processing system configured to detect an event associated with a website indicative of a change in the website to an undesired state, dynamically generate a restoration process, employ the restoration process to restore the website to a desired state, and employ a verification process to verify that the website has been restored to the desired state.

10. The system of claim 9 further comprising the processing system configured to receive user input specifying sub-processes for inclusion within the restoration process.

11. The system of claim 9 wherein the processing system configured to dynamically generate the restoration process comprises the processing system configured to dynamically generate the restoration process in response to detecting the event.

12. The system of claim 9 further comprising, if employing the verification process fails to verify that the website has been restored to the desired state, then the processing system is configured to dynamically generate a second restoration process, employ the second restoration process to restore the website to the desired state, and employ a second verification process to verify that the website has been restored to the desired state.

13. The system of claim 12 wherein the processing system configured to employ the restoration process comprises the processing system configured to restore a portion of code associated with the website, and wherein the processing system configured to employ the second restoration process comprises the processing system configured to restore the website to a previous version of the website using an entire backup of the website.

14. The system of claim 9 wherein the event comprises a decline in reputation of the website.

15. The system of claim 9 wherein the event comprises artifacts created by a malware attack.

16. The system of claim 9 wherein the event comprises a malfunction of the website, and wherein a cause of the malfunction is unknown when the event is detected.

17. A computer-readable medium having program instructions stored thereon for operating an event-driven auto-restoration system for websites, the computer-readable medium comprising:
a monitoring software module configured to direct the event-driven auto-restoration system to detect an event associated with a website indicative of a change in the website to an undesired state,
a restoration software module configured to direct the event-driven auto-restoration system to dynamically generate a restoration process and employ the restoration process to restore the website to a desired state; and
a verification software module configured to direct the event-driven auto-restoration system to employ a verification process to verify that the website has been restored to the desired state.

18. The computer-readable medium of claim 17 further comprising a control and interface software module configured to direct the event-driven auto-restoration system to receive user input specifying sub-processes for inclusion within the restoration process.

19. The computer-readable medium of claim 17 wherein the restoration software module configured to direct the event-driven auto-restoration system to dynamically generate the restoration process comprises the restoration software module configured to direct the event-driven auto-restoration system to dynamically generate the restoration process in response to detecting the event.

20. The computer-readable medium of claim 17 further comprising, if employing the verification process fails to verify that the website has been restored to the desired state, then the restoration software module is configured to direct the event-driven auto-restoration system to dynamically generate a second restoration process and employ the second restoration process to restore the website to the desired state, and the verification software module is configured to employ a second verification process to verify that the website has been restored to the desired state.

21. The computer-readable medium of claim 20 wherein the restoration software module configured to direct the event-driven auto-restoration system to employ the restoration process comprises the restoration software module configured to direct the event-driven auto-restoration system to restore a portion of code associated with the website, and wherein the restoration software module configured to direct the event-driven auto-restoration system to employ the second restoration process comprises the restoration software module configured to direct the event-driven auto-restoration system to restore the website to a previous version of the website using an entire backup of the website.

22. The computer-readable medium of claim 17 wherein the event comprises a decline in reputation of the website.

23. The computer-readable medium of claim 17 wherein the event comprises artifacts created by a malware attack.

24. The computer-readable medium of claim 17 wherein the event comprises a malfunction of the website, and wherein a cause of the malfunction is unknown when the event is detected.
